(19) United States
(12) Patent Application Publication
(10) Pub. No.: US 2016/0005071 A1
(43) Pub. Date: Jan. 7, 2016

(54) REPLACING ADS DYNAMICALLY TO INCREASE THEIR SUCCESS

(71) Applicant: International Business Machines Corporation, Armonk, NY (US)

(72) Inventors: Yuk L. Chan, Poughkeepsie, NY (US); Michael D. Essenmacher, Red Hook, NY (US); James M. Hertzig, Tillson, NY (US); David B. Lection, Raleigh, NC (US); Mark A. Scott, Rhinebeck, NY (US)

(21) Appl. No.: 14/854,070

(22) Filed: Sep. 15, 2015

Related U.S. Application Data
(63) Continuation of application No. 14/257,157, filed on Apr. 21, 2014.

(51) Int. Cl. G06Q 30/02

(52) U.S. Cl. CPC G06Q 30/0254

(57) ABSTRACT

In one embodiment, a computer-implemented method includes identifying a plurality of channels on a computing device, each channel being capable of displaying ads. It is determined that an ad has been queued for display with a set of initial ad properties, the initial ad properties referencing a source channel from among the channels. A success potential is determined for the ad if displayed on the source channel, and a success potential is determined for the ad if displayed on a second channel. A destination channel is selected, by a computer processor, from between the source channel and the second channel, based at least on comparing the success potentials. A set of modified ad properties is produced based on the initial ad properties, where the destination channel replaces the source channel in the modified ad properties. A replacement ad having the modified ad properties is then delivered to the destination channel.

### DOMESTIC PRIORITY

This application is a continuation application of the legally related U.S. Ser. No. 14/257,157 filed Apr. 21, 2014, the contents of which are incorporated by reference herein in their entirety.

### BACKGROUND

Various embodiments of this disclosure relate to advertising and, more particularly, to dynamically replacing ads to increase advertiser success.

Advertisement is the de facto mechanism to generate revenue for online websites. As technological trends move to the mobile platform, the costs of providing information and services may increase because of costs associated with network bandwidth and mobile platform data usage. Advertisements provide a way for users to enjoy free information and services, while compensating the provider of the information and services by way of advertisers.

Advertisements become an annoyance on the mobile platform because of the smaller viewable area and slower data transmission speed on mobile devices, as compared to larger computing devices. Technological advances such as streamed video, streamed audio, and flash worsen this situation. For example, video clips online often begin with ten to thirty seconds of video advertisement, and standard webpages often contain embedded flash adds. With advertisements occupying part of the screen, causing longer load times, and consuming network bandwidth, ads have a significantly negative impact on users and their experiences on mobile platforms. This results in a loss of productivity. Further, because the ads are often an annoyance to users, the success of these ads may be lower than desirable to advertisers.

### SUMMARY

In one embodiment of this disclosure, a computer-implemented method includes identifying a plurality of channels on a computing device, each channel being capable of displaying ads. It is determined that an ad has been queued for display with a set of initial ad properties, the initial ad properties referencing a source channel from among the plurality of channels. A success potential is determined for the ad if displayed on the source channel, and a success potential is determined for the ad if displayed on a second channel. A destination channel is selected, by a computer processor, from between the source channel and the second channel, based at least on comparing the success potential of the ad on the source channel to the success potential of the ad on the second channel. A set of modified ad properties is produced based on the initial ad properties, where the destination channel replaces the source channel in the modified ad properties. A replacement ad having the modified ad properties is then delivered to the destination channel.

In another embodiment, a system includes an ad monitor, a selection unit, and an ad provider. The an ad monitor is configured to identify a plurality of channels on a computing device, each channel being capable of displaying ads, and to determine that an ad has been queued for display with a set of initial ad properties, the initial ad properties referencing a source channel from among the plurality of channels. The selection unit is configured to determine a success potential of the ad if displayed on the source channel; determine a success potential of the ad if displayed on a second channel; select a destination channel from between the source channel and the second channel, based at least on comparing the success potential of the ad on the source channel to the success potential of the ad on the second channel; and produce a set of modified ad properties based on the initial ad properties, where the destination channel replaces the source channel in the modified ad properties. The ad provider is configured to deliver to the destination channel a replacement ad having the modified ad properties.

In yet another embodiment, a computer program product includes a computer readable storage medium having computer readable program code embodied thereon. The computer readable program code is executable by a processor to perform a method. The method includes identifying a plurality of channels on a computing device, each channel being capable of displaying ads. Further according to the method, it is determined that an ad has been queued for display with a set of initial ad properties, the initial ad properties referencing a source channel from among the plurality of channels. A success potential is determined for the ad if displayed on the source channel, and a success potential is determined for the ad if displayed on a second channel. A destination channel is selected from between the source channel and the second channel, based at least on comparing the success potential of the ad on the source channel to the success potential of the ad on the second channel. A set of modified ad properties is produced based on the initial ad properties, where the destination channel replaces the source channel in the modified ad properties. A replacement ad having the modified ad properties is then delivered to the destination channel.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a block diagram of a computing device on which an ad replacement system may be implemented, in whole or in part, according to an exemplary embodiment of this disclosure;

FIG. 2 is a block diagram of the ad replacement system, according to an exemplary embodiment of this disclosure; and

FIG. 3 is a flow diagram of a method for replacing an ad, according to an exemplary embodiment of this disclosure.

### DETAILED DESCRIPTION

Various embodiments of this disclosure are ad replacement systems and methods that provide an improved experience to computing device users with respect to advertisements, by enabling a first ad queued for display to be replaced by a second ad prior to the display. The second ad may have a different set of as properties, including the channel on which the ad is displayed, the ad format, or the actual content of the ad. As a result, an ad may be effectively transferred from one channel to another, from one format to another, or from one content to another. Additionally, advertisers may receive better results from their ads, as transfers may be made to improve the click-through rates (CTRs).

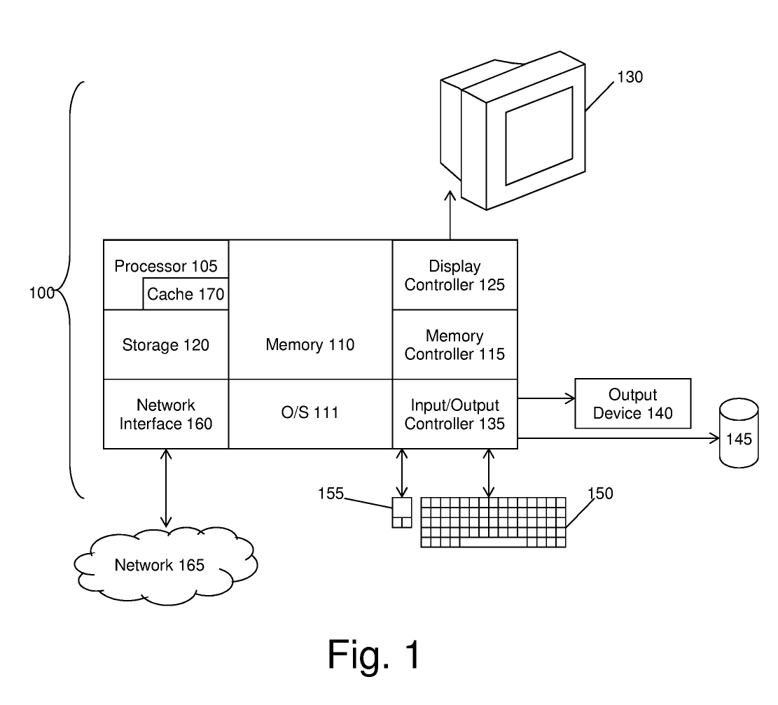

FIG. 1 illustrates a block diagram of a computer system 100 for use in implementing an ad replacement system or method according to some embodiments. The ad replacement systems and methods described herein may be implemented in hardware, software (e.g., firmware), or a combination thereof. In an exemplary embodiment, the methods described may be implemented, at least in part, in hardware and may be part of the microprocessor of a special or general-purpose computer system 100, such as a personal computer, workstation, minicomputer, or mainframe computer.

In an exemplary embodiment, as shown in FIG. 1, the computer system 100 includes a processor 105, memory 110 coupled to a memory controller 115, and one or more input and/or output (I/O) devices 140 and 145, such as peripherals, that are communicatively coupled via a local I/O controller 135. The I/O controller 135 may be, for example but not limitation, one or more buses or other wired or wireless connections, as are known in the art. The I/O controller 135 may have additional elements, which are omitted for simplicity, such as controllers, buffers (caches), drivers, repeaters, and receivers, to enable communications.

The processor 105 is a hardware device for executing hardware instructions or software, particularly those stored in memory 110. The processor 105 may be any custom made or commercially available processor, a central processing unit (CPU), an auxiliary processor among several processors associated with the computer system 100, a semiconductor based microprocessor (in the form of a microchip or chip set), a macroprocessor, or other device for executing instructions. The processor 105 includes a cache 170, which may include, but is not limited to, an instruction cache to speed up executable instruction fetch, a data cache to speed up data fetch and store, and a translation lookaside buffer (TLB) used to speed up virtual-to-physical address translation for both executable instructions and data. The cache 170 may be organized as a hierarchy of more cache levels (L1, L2, etc.).

The memory 110 may include any one or combinations of volatile memory elements (e.g., random access memory, RAM, such as DRAM, SRAM, SDRAM, etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 110 may incorporate electronic, magnetic, optical, or other types of storage media. Note that the memory 110 may have a distributed architecture, where various components are situated remote from one another but may be accessed by the processor 105.

The instructions in memory 110 may include one or more separate programs, each of which comprises an ordered listing of executable instructions for implementing logical functions. In the example of FIG. 1, the instructions in the memory 110 include a suitable operating system (OS) 111. The operating system 111 essentially may control the execution of other computer programs and provides scheduling, input-output control, file and data management, memory management, and communication control and related services.

Additional data, including, for example, instructions for the processor 105 or other retrievable information, may be stored in storage 120, which may be a storage device such as a hard disk drive.

In an exemplary embodiment, a conventional keyboard 150 and mouse 155 may be coupled to the I/O controller 135. Other output devices such as the I/O devices 140 and 145 may include input devices, for example but not limited to, a printer, a scanner, a microphone, and the like. The I/O devices 140, 145 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like.

The computer system 100 may further include a display controller 125 coupled to a display 130. In an exemplary embodiment, the computer system 100 may further include a network interface 160 for coupling to a network 165. The network 165 may be an IP-based network for communication between the computer system 100 and any external server, client and the like via a broadband connection. The network 165 transmits and receives data between the computer system 100 and external systems. In an exemplary embodiment, the network 165 may be a managed IP network administered by a service provider. The network 165 may be implemented in a wireless fashion, e.g., using wireless protocols and technologies, such as WiFi, WiMax, etc. The network 165 may also be a packet-switched network such as a local area network, wide area network, metropolitan area network, the Internet, or other similar type of network environment. The network 165 may be a fixed wireless network, a wireless local area network (LAN), a wireless wide area network (WAN) a personal area network (PAN), a virtual private network (VPN), intranet or other suitable network system and may include equipment for receiving and transmitting signals.

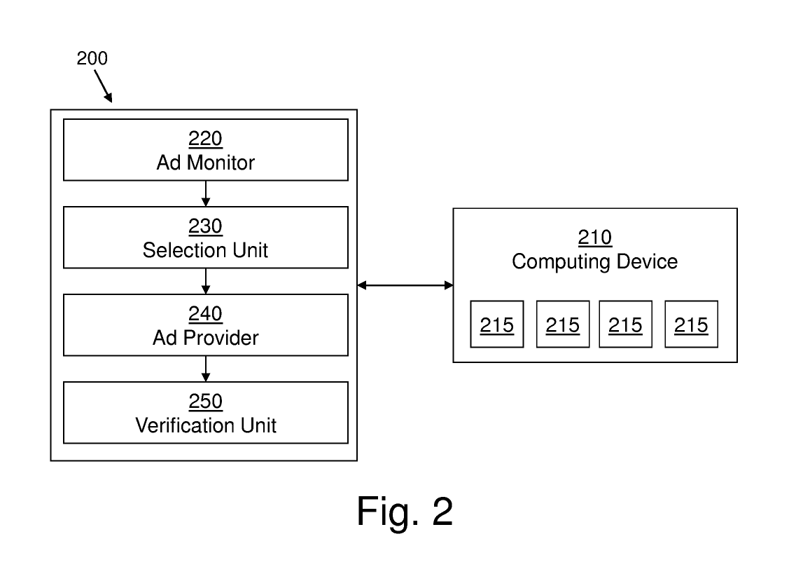

FIG. 2 is a block diagram of an ad replacement system 200, according to an exemplary embodiment of this disclosure. In an exemplary embodiment, at least some aspects of the ad replacement system 200 may be embodied in or configured to run on a computing device 210, such as the computer system 100 of FIG. 1, which may be a mobile device, a notebook computer, a laptop computer, or other computing device. The computing device 210 may have two or more channels 215 by which advertisements may be delivered to a user of the computing device 210. These channels 215 may include, for example, a web browser, an application, or a specific website. Each channel 215 may be capable of displaying an ad, and the ad replacement system 200 may be configured to direct each channel to display ads as needed.

As shown in FIG. 2, the ad replacement system 200 may include an ad monitor 220, a selection unit 230, an ad provider 240, and a verification unit 250. Generally, the ad monitor 220 may identify ads to be potentially replaced by the ad replacement system 200. The selection unit 230 may select one or more modifications for the ads. The ad provider 240 may then provide the replacement ads, as modified by the selection unit 230, to one or more channels 215 of the computing device 210.

The ad replacement system 200 may seek to improve the CTR of advertisements displayed to the user, while also reducing the intrusiveness of ads on the user's experience. In an exemplary embodiment, the advertisement modification system 200 may replace a queued ad with a second ad, where the second ad is displayed in place of the queued ad, and where the second ad includes modified ad properties as compared to the queued ad. Such modifications to the ad properties may include changing the display channel 215 on the computing device 210 so as to transfer the queued ad to a different channel 215. The modifications may further include, for example, changing the format of the ad, changing the content of the ad, or a combination of these modifications. In an exemplary embodiment, the selected modifications may improve the CTR. It will be understood that, although this disclosure refers to the CTR as an exemplary measurement for ad effectiveness, other measures may be used alternatively or additionally. For example, and not by way of limitation, conversion rates may be used in some embodiment of the ad replacement system 200, in lieu of CTRs.

The ad monitor 220 may run locally on the computing device 210, remotely on a central server, or may be distributed so that it runs across one or more computer systems 100. The ad monitor 220 may be configured to detect when an ad is being queued for display on one of the channels 215 to which the ad monitor 220 has access. The ad monitor 220 may intercept the ad before its display, to enable replacement of the ad.

Various means can be used by the ad monitor 220 to determine that an ad is being queued for display. For example, and not by way of limitation, one or more processes of the ad monitor 220 may run in an operating system of the computing device 210. In that case, the ad monitor 220 may be configured to monitor various applications and processes on the computing device 210 and may thus detect when an ad is queued. For another example, a process of the ad monitor 220 may run inside the channels 215, such as being integrated into an application associated with a channel 215. In that case, the application itself may notify the ad replacement system 200 of the queued ad. For another example, an application associated with a channel 215 may be in communication with a remote application server, which may direct the application as to when to display ads and what ads to display. In that case, a process of the ad monitor 220 may run on the remote application server. It will be understood that various implementations for the ad monitor 220 may be used to determine when an ad is queued for display.

When an ad is queued, that ad may be associated with a set of initial ad properties, which may be identified by the ad monitor 210. The ad properties may include one or more of the following: identification of a channel 215 to which the ad is directed, a format of the ad, and content for the ad. After it is determined that an ad has been queued, the selection unit 230 may seek to replace the ad by providing a second ad with modified ad properties, as compared to the ad that was initially queued. In an exemplary embodiment, modifications may be selected using a predetermined modification algorithm and may be aimed toward improving the CTR of the queued ad given its initial ad properties.

The selection unit 230 may determine a CTR for the queued ad with its initial ad properties. It will be understood that various means may be used for determining the CTR, which may be based on historical click-throughs, predicted click-throughs, default values, or a combination thereof. Additionally, the CTR may be based on the user's click-throughs, the click-throughs for all or a collection of users, the click-throughs for a class of users to which the user belongs, or a combination of these. In some embodiments, a CTR for an ad with a specific set of ad properties may be dynamic, changeable when new data regarding click-throughs is received or generated. It will be further understood that the term CTR, throughout this disclosure, refers to a CTR that may be calculated through various means or to some other method of calculating ad success.

The selection unit 230 may modify the ad properties by selecting a destination channel 215 for the queued ad. In some embodiments, the initial ad properties may include a source channel 215, where the queued ad is initially directed for display. In that case, when the ad properties are modified to include the destination channel 215, the destination channel 215 may replace the source channel 215 in the modified ad properties and may or may not be the same as the source channel 215. In choosing a destination channel 215, the selection unit 230 may seek to maximize, or at least increase, the CTR of the queued ad, or may seek to better meet the user preferences for ads. If a source channel 215 exists, the selection unit 230 may seek to improve the CTR of the queued ad over the CTR if the queued ad were displayed on the source channel 215.

The selection unit 230 may determine the CTR of the queued ad on the source channel 215 and may also determine the CTR of the queued ad on one or more other channels 215 of the computing device 210. The means used to determine these CTRs may be implementation-dependent. In some embodiments, the CTRs may be calculated by the selection unit 230 on an as-needed basis. In some other embodiments, the selection unit 230 may retrieve previously calculated CTRs. From the various channels 215 being considered, the selection unit 230 may select one of such channels 215 as the destination channel 215 based at least in part on the determined CTR of the selected channel. For example, and not by way of limitation, the selection unit 230 may select the channel 215 with the highest CTR, or the channel 215 with the highest CTR that complies with user preferences. In some embodiments, the destination channel 215 may be selected such that the queued ad's CTR on the destination channel 215 is at least as high as the queued ad's CTR on the source channel 215.

An ad may be provided in various formats, including, for example, image, video, flash, audio, or banner. When an ad is queued, its initial ad properties may or may not include a source formal for the ad, i.e., a format in which the queued ad is to be provided. The selection unit 230 may modify the ad properties by selecting a destination format for the ad. If a source format is provided in the initial ad properties, then the destination format may replace the source format in the ad properties. The destination format may or may not be the same as the source format.

As with selecting a destination channel 215, the selection unit 230 may compare the CTR of the queued ad in its source format with the CTR of the queued ad in other possible formats, and the CTRs of these other potential formats may be compared to one another as well. In some embodiments, formats excluded by the user's preferences need not be considered as potential destination formats. The selection unit 230 may select a destination format from among the source format and the other possible formats based at least in part on the CTR of the queued ad in these formats. In an exemplary embodiment, the selection unit 230 may select the format that gives the highest CTR, or improves the CTR over the source format of the queued ad.

In some exemplary embodiments, the selection unit 230 may modify the ad properties by selecting a destination content for the queued ad, which may be the actual content provided when the ad is displayed or which may be a content category from which the actual content is eventually chosen. The initial ad properties may or may not include a source content. If a source content is included in the ad properties, the selection unit 230 may replace the source content with the destination content. The selection unit 230 may compare the CTR of the queued ad with the source content to the CTRs of other potential ad content options applied to the queued ad, which other potential ad content options may also be compared to one another. For example, and not by way of limitation, the source content may be an advertisement for a beverage, but the selection unit 230 may determine that clothing advertisements tend to have higher CTRs for users deemed similar to the user in question. Further, the selection unit 230 may determine that a specific clothing ad or clothing ads from a particular type of store tend to have higher CTRs. In that case, the beverage content may be replaced by clothing ad content in the ad properties. The selection unit 230 may select a destination content from among the source content and the other potential contents based at least in part on the CTR of the queued ad with these contents. In an exemplary embodiment, the selection unit 230 may select the content that gives the highest CTR, or improves the CTR over the source content of the queued ad.

In making its various selections for channel, format, or content, the selection unit 230 may consider one or more user preferences set by the user of the computing device. For example, and not by way of limitation, the user may indicate that certain channels, formats, or contents are off-limits for ads. When user preferences are indicated, the selection unit 230 may follow, or at least consider, these preferences when making its selections. In some embodiments, the selection unit 230 may select modified ad properties that reduce the queued ad's CTR in order to meet the user's preferences, as displaying unwanted ads will likely not achieve click-throughs. In that case, the selection unit 230 may replace the queued ad with multiple ad instances, so as to improve the CTR.

It will be understood that application of above the above-described potential modifications of the ad properties may be applied in various ways. Further, if the selection unit 230 is capable of making selections relating to two or more of the channel 215, format, and ad content, then the selection unit 230 may need to prioritize or follow an order of operations to determine the order in which the selections for the ad properties are made. For example, and not by way of limitation, if the destination channel 215 is chosen before the destination format is chosen, a different result may be achieved than if the destination format is chosen before the destination channel 215. A modification algorithm may be followed to determine how and whether modifications to the ad properties are selected.

The ad replacement system 200 may be required to provide certain ads according to certain frequencies or other guidelines, based on agreements with ad purchasers that provide the ads. In that case, some ad may have proven more successful than other ads in the past, but despite this history, the less successful ads must still be shown. Additionally, some users that could be serviced by the ad replacement system 200 may opt out of ad replacement or may provide user preferences that limit ad replacement. In a first embodiment of the ad replacement system 200, the selection unit 230 may select a relatively high percentage of ads with high CTRs for those users who have ad replacement enabled, and may display ads with lower CTRs to users who disallow ad replacement. In this manner, the ad replacement system 200 may satisfy its requirements to provide certain ads, while giving a relatively high chance of click-throughs for ads that have proven to be successful in the past.

In another embodiment of the ad replacement system 200, in accordance with a predetermined modification algorithm, the selection unit 230 may first assume that a destination channel 215 will be chosen for a queued ad, but the content and format will remain unchanged. The selection unit 230 may then compare the queued ad's CTR on the source channel 215 versus a second channel 215. Whichever has the higher CTR may then be selected as the destination channel 215 and included in the modified ad properties. The selection unit 230 may then compare the queued ad, based on its current ad properties with the selected destination channel 215 and source format, to the queued ad if displayed in a second ad format. The format with the higher CTR may be selected as the destination format and added to the modified ad properties. The selection unit 230 may then compare the queued ad, based on its current ad properties with the selected destination channel 215 and destination format, to the CTR of the queued ad with the current ad properties except using a second content other than the source content. The content providing the higher CTR may be selected as the destination content and added to the modified ad properties as such. It will be understood that various means and orders of making the various selections for the modified ad properties may be used.

After various selections are made by the selection unit 230, the ad provider 240 may deliver, instead of the queued ad, a replacement ad with the modified ad properties, which include the selections made by the selection unit 230. In some embodiments, when making various selections to modify the ad properties, the selection unit 230 may select two or more destination channels 215, formats, or contents. This may be the case, for example, if delivering the ad multiple times is necessary to increase the CTR of the replacement ad above the CTR based on the initial ad properties of the queued ad. If multiple ads are required based on the inclusion of two or more destination channels 215, formats, or contents existing in the final ad properties, then when the ad provider 240 delivers the queued ad, it may deliver the queued ad multiple times or in multiple versions with the various selected options.

In some embodiments, a verification unit 250 may verify that the replacement ad was viewed by the user, by receiving an acknowledgement from the user when the ad is viewed. This may be particularly useful where the selection unit 230 chooses a destination channel 215 other than the source channel 215, or if no source channel 215 was provided. For example, and not by way of limitation, if a user is browsing the internet using a browser app, and an ad is queued, the browser app may be the source channel 215 for the queued ad. The selection unit 230 may select the user's email as a destination channel 215. In that case, the user may provide acknowledgement that he has viewed the emailed ad, such as by clicking a link or button in the email. The acknowledgement may be provided in various other ways, including captcha or answering a question. It may often be that case that, when an ad is transferred to a destination channel 215, the user is not currently using the destination channel 215. Thus, ad acknowledgement may be used to keep the CTRs accurate and to ensure that the user is not attempting to cheat the system by having ads transferred to channels 215 the user does not check.

In some embodiments, the source channel 215 on which the ad was initially queued may wait for the acknowledgement to be received, and may pause execution until the acknowledgement occurs. In some other embodiments, the ad replacement system 200 may disable ad replacement or, at least, ad property modifications that involve channel transfers, when the user's acknowledgement percentage (i.e., the percentage of ads transferred and later verified) is below a predetermined threshold. When ad replacement is disabled completely or with respect to specific channels 215, the selection unit 230 may opt not to modify the ad properties for future queued ads, or it may make selections that exclude the disabled options.

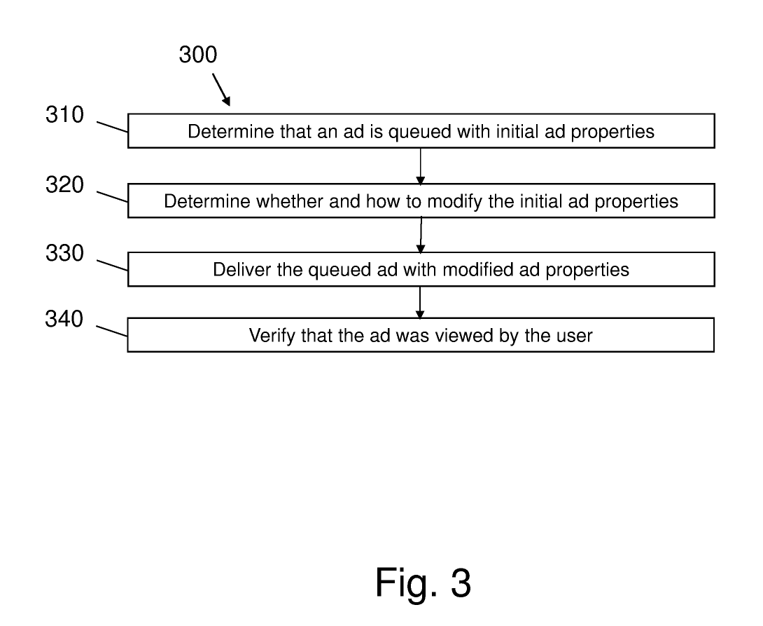

FIG. 3 shows a block diagram of a method 300 for replacing an ad, according to an exemplary embodiment of this disclosure. As shown in FIG. 3, at block 310, the ad monitor 220 determines that an ad is queued for display with an initial set of ad properties. At block 320, the selection unit 230 determines whether to modify the ad properties and selects modifications. At block 330, the ad provider 240 delivers a replacement ad with modified ad properties, to a destination channel in a destination format and with a destination content selected by the selection unit 230. At block 340, the verification unit 250 verifies that the replacement ad was viewed by the user.

Thus, according to some embodiments of this disclosure, the ad replacement system 200 may provide a less intrusive user experience by considering user preferences when providing ads. The ad replacement system 200 may also improve CTRs for the benefit of advertisers, by providing ads in a way that is tailored to user preferences and past success.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

Further, as will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radio frequency (RF), etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
identifying a plurality of channels on a computing device, each channel being capable of displaying ads;
determining that an ad has been queued for display with a set of initial ad properties, the initial ad properties referencing a source channel from among the plurality of channels;
determining a success potential of the ad if displayed on the source channel;
determining a success potential of the ad if displayed on a second channel;
selecting, by a computer processor, a destination channel from between the source channel and the second channel, based at least on comparing the success potential of the ad on the source channel to the success potential of the ad on the second channel;
producing a set of modified ad properties based on the initial ad properties, wherein the destination channel replaces the source channel in the modified ad properties; and
delivering to the destination channel a replacement ad having the modified ad properties.

2. The method of claim 1, wherein the initial ad properties reference a source format of the ad, the method further comprising:
determining a success potential of the ad if displayed in the source format;
determining a success potential of the ad if displayed in a second format;
selecting a destination format from between the source format and the second format, based at least on comparing the success potential of the ad in the source format to the success potential of the ad in the second format; and
including the destination format in place of the source format in the modified ad properties.

3. The method of claim 1, wherein the initial ad properties reference a source content of the ad, the method further comprising:
determining a success potential of the ad if displayed with the source content;
determining a success potential of the ad if displayed with a second content;
selecting a destination content from between the source content and the second content, based on comparing the success potential of the ad with the source content to the success potential of the ad with the second content; and
including the destination content in place of the source content in the modified ad properties.

4. The method of claim 1, wherein selecting the destination channel comprises selecting as the destination channel the one of the source channel and the second channel with the higher success potential.

5. The method of claim 1, further comprising receiving an acknowledgement that the ad has been viewed by the user.

6. The method of claim 1, further comprising receiving a set of user preferences, wherein selecting the destination channel from between the source channel and the second channel comprises complying with the user preferences

7. The method of claim 1, wherein determining the success potential of the ad if displayed on the source channel comprises determining a click-through rate of the ad if displayed on the source channel.
